(19) United States
(12) Patent Application Publication
(10) Pub. No.: US 2019/0138779 A1
(43) Pub. Date: May 9, 2019

(54) METHOD AND APPARATUS FOR FINGERPRINT RECOGNITION

(71) Applicant: ELECTRONICS AND TELECOMMUNICATIONS RESEARCH INSTITUTE, Daejeon (KR)

(72) Inventors: Jung Yeon HWANG, Daejeon (KR); Youngsam KIM, Daejeon (KR); Hyung-Kyun KIM, Yongin-si (KR); Sangrae CHO, Daejeon (KR); Seung-Hyun KIM, Daejeon (KR); Soo Hyung KIM, Daejeon (KR); Jong-Hyouk NOH, Daejeon (KR); Young Seob CHO, Daejeon (KR); Jin-Man CHO, Daejeon (KR); Seung Hun JIN, Daejeon (KR); Seyoung HUH, Daejeon (KR)

(73) Assignee: ELECTRONICS AND TELECOMMUNICATIONS RESEARCH INSTITUTE, Daejeon (KR)

(21) Appl. No.: 16/182,600

(22) Filed: Nov. 6, 2018

(30) Foreign Application Priority Data
Nov. 7, 2017 (KR) 10-2017-0147502
Jun. 4, 2018 (KR) 10-2018-0064472

(51) Int. Cl. G06K 9/00

(52) U.S. Cl. CPC G06K 9/001; G06K 9/0004; G06K 9/0008

(57) ABSTRACT

A method and an apparatus for fingerprint recognition are disclosed. The apparatus for the fingerprint recognition may extract a plurality of fingerprint feature points from a fingerprint image and may configure a group among the plurality of fingerprint feature points. The apparatus for the fingerprint recognition may also calculate a distance value between first fingerprint feature points included in the group and may use the distance value to generate a distance value sequence.

### CROSS-REFERENCE TO RELATED APPLICATION

This application claims priority to and the benefit of Korean Patent Application Nos. 10-2017-0147502 and 10-2018-0064472 filed in the Korean Intellectual Property Office on Nov. 7, 2017 and Jun. 4, 2018, respectively, the entire contents of which are incorporated herein by reference.

### BACKGROUND OF THE INVENTION

### (a) Field of the Invention

The present invention relates to a method and an apparatus for fingerprint recognition.

### (b) Description of the Related Art

A biometric recognition technology using fingerprint information has been researched for a long period of time, and various methods are known. A fingerprint refers to a shape created based on a line in which a sweat gland of skin at the tip of the finger is raised, that is, a ridge. A depressed part between ridges is referred to as a valley. Overall, the ridge may be formed along a constant path and may be divided into a bow pattern, a swirl pattern, a horseshoe pattern, and the like. The shape of the fingerprint is different for every person, and it has been actively researched as a unique biometric recognition means up to now.

As basic feature information for the fingerprint recognition, two points based on local features of the ridge pattern are considered. These two points are an ending point where the ridge is interrupted and a bifurcation point where the line is branched. In detail, general feature information for the fingerprint recognition is expressed by coordinate values x and y on the fingerprint image of the points, an angle θ of the ridge of each point, and a characteristic bit information value b representing whether the point is a bifurcation point or an ending point. These contents are already widely known in international standards such as ISO/IEC 19794.

Basically, biometric information is influenced by many environmental variables, so the same biological image may not be acquired every time. In the case of the fingerprints, different fingerprint images may be obtained each time because of non-uniform pressure from a user, rotation deformation, and foreign material insertion, such as sweat or dust, when using a fingerprint authentication system. As a result, geometric deformation occurs in the extracted feature information, thereby making it difficult to achieve an adequate recognition rate.

Fingerprint recognition methods and systems that enhance the recognition rate of fingerprints and are robust to geometric transformation of fingerprint images are being studied. One of typical methods is to use a distance between two feature points (minutiae). Since the fingerprint feature points can be represented by a two-dimensional coordinate value vector (x, y) on the fingerprint image, the distance value can be calculated between the fingerprint feature points (minutiae). There can be various distance functions on a multidimensional vector coordinate system including two dimensions. For example, the Euclidean distance function is typically used to calculate the distance between two points. In addition to the Euclidean distance function, there are various distance functions such as a squared Euclidean distance, a non-Euclidean distance, a Manhattan distance, a cosine distance, and a Tanimoto distance (or a Jaccard distance).

Generally, in the method of using the distance in fingerprint recognition, a distance error between fingerprint feature points registered after alignment of two fingerprint images and fingerprint feature points obtained in authentication are calculated and determined.

In contrast to the general method, a triangular ridge method is known, in which a group of fingerprint feature points are defined in one fingerprint image, and a group of distance values between feature points is used. An example of such a method is U.S. Pat. No. 8,971,596. The triangular ridge method (U.S. Pat. No. 8,971,596) calculates length information of each side of a triangle composed of three fingerprint feature points as a similarity score.

Since the triangular ridge method considers a small number of fingerprint feature points as one group and then uses the distance value between the fingerprint feature points in the group as the feature information, only local characteristics are reflected in the fingerprint recognition. This method is vulnerable to insertion, deletion, and movement of fingerprint feature points because it uses only predetermined fingerprint feature points or distance value information between specific fingerprint feature points along a certain region or a predetermined rule.

In fingerprint recognition, insertion and deletion of fingerprint feature points according to ridge flow must be considered important. That is, dynamic motion or statistical frequency values need to be reflected in a fingerprint matching process. Due to a distribution of similar triangular ridges, the triangular ridge method has a limitation in using the side length information in fingerprint recognition. Also, when the distance information between the two fingerprint feature points is used as the feature information, a similar weakness is shown, and it may be difficult to achieve a good recognition rate without alignment.

### SUMMARY OF THE INVENTION

The present invention provides a fingerprint recognition method and apparatus for enhancing a fingerprint recognition rate and performing fingerprint matching that is robust against an image change.

According to an exemplary embodiment of the present invention, a method for performing fingerprint recognition by using a fingerprint image scanned by a fingerprint recognition apparatus is provided. The method may include extracting a plurality of fingerprint feature points in the fingerprint image, configuring a predetermined group among the plurality of fingerprint feature points, calculating a distance value between first fingerprint feature points included in the group, and generating a distance value sequence by using the distance value.

The calculating may include configuring a reference fingerprint feature point as a reference among the first fingerprint feature points, and calculating a distance value between the reference fingerprint feature point and the first fingerprint feature points.

The generating may include generating the distance value sequence between the reference fingerprint feature point and the first fingerprint feature points, by arranging the distance value calculated in a predetermined direction.

The method may further include performing authentication by using the distance value sequence.

The performing authentication may include performing authentication by comparing a registration distance value sequence as the distance value sequence generated in a registration process and an authentication distance value sequence as the distance value sequence generated in an authentication process.

The performing authentication may include disposing the registration distance value sequence in a first direction on a matrix, disposing the authentication distance value sequence in a second direction on the matrix, calculating a value difference of the registration distance value sequence and the authentication distance value sequence, and calculating a score of a similarity by using a feature on which the value difference is disposed on the matrix.

The calculating of the score of the similarity may include calculating the score of the similarity by using a feature in which the value difference is 0 or a certain range of the value differences is continuously disposed on a diagonal on the matrix.

The plurality of fingerprint feature points may include an ending point of a ridge and a bifurcation point of the ridge.

The predetermined direction is a clockwise direction or a counterclockwise direction.

According to another exemplary embodiment of the present invention, a method for performing fingerprint recognition by a fingerprint recognition apparatus is provided. The methods may include extracting a plurality of first fingerprint feature points on a fingerprint image to be registered, generating a registration distance value sequence by calculating a distance value between the plurality of first fingerprint feature points, extracting a plurality of second fingerprint feature points on a fingerprint image to be authenticated, generating an authentication distance value sequence by calculating a distance value between the plurality of second fingerprint feature points, and performing authentication by comparing the registration distance value sequence and the authentication distance value with each other.

The generating of the registration distance value sequence may include configuring a first fingerprint feature point from the plurality of first fingerprint feature points, calculating a distance value in a predetermined direction between at least one fingerprint feature point among the plurality of first fingerprint feature points and the first fingerprint feature point, and generating the registration distance value sequence by arranging the distance value calculated in the predetermined direction.

The generating of the authentication distance value sequence may include configuring a first fingerprint feature point from the plurality of second fingerprint feature points, calculating a distance value in a predetermined direction between at least one fingerprint feature point among the plurality of second fingerprint feature points and the first fingerprint feature point, and generating the authentication distance value sequence by arranging the distance value calculated in the predetermined direction.

The performing of authentication may include disposing the registration distance value sequence in a first direction on a matrix, disposing the authentication distance value sequence in a second direction on the matrix, calculating a value difference of the registration distance value sequence and the authentication distance value sequence, and performing authentication by using a feature on which the value difference is disposed on the matrix.

The disposing in the first direction may include consecutively disposing the registration distance value sequence in the first direction twice, and the disposing in the second direction may include consecutively disposing the authentication distance value sequence in the second direction twice.

According to another exemplary embodiment of the present invention, an apparatus for fingerprint recognition is provided. The apparatus for fingerprint recognition may include a scan unit scanning a fingerprint of a target to be recognized to generate a fingerprint image, and a controller extracting a plurality of fingerprint feature points from the fingerprint image, calculating a distance value between the plurality of fingerprint feature points, and generating a distance value sequence by using the distance value.

The controller may configure a reference fingerprint feature point as a reference among the plurality of fingerprint feature points, and calculate a distance value between the reference fingerprint feature point and the plurality of fingerprint feature points.

The controller may arrange the distance value calculated in a predetermined direction between the reference fingerprint feature point and the plurality of fingerprint feature points to generate the distance value sequence.

The fingerprint image may include a registration fingerprint image scanned in a registration process and an authentication fingerprint image scanned in an authentication process, and the controller may compare a registration distance sequence as the distance value sequence corresponding to the registration fingerprint image and an authentication distance value sequence as the distance value sequence corresponding to the authentication fingerprint image with each other to perform authentication.

The controller may dispose the registration distance value sequence and the authentication distance value sequence in different directions on a matrix, calculate a value difference of the registration distance value sequence and the authentication distance value sequence, and perform authentication by using a feature on which the value difference is disposed on the matrix.

The plurality of fingerprint feature points may be an ending point of a ridge or a bifurcation point of the ridge, and the predetermined direction is a clockwise direction or a counterclockwise direction.

According to an exemplary embodiment of the present invention, the distance value sequence is generated to be used for fingerprint authentication, thereby further increasing accuracy of fingerprint recognition.

### BRIEF DESCRIPTION OF THE DRAWINGS

FIG. 1 is a block diagram showing a fingerprint recognition apparatus according to an exemplary embodiment of the present invention.

FIG. 2 is a block diagram showing a configuration of a controller 120 according to an exemplary embodiment of the present invention.

FIG. 3 is a diagram showing a method in which a controller generates a distance value sequence according to an exemplary embodiment of the present invention.

FIG. 4 is a diagram showing an authentication method of a controller according to an exemplary embodiment of the present invention.

FIG. 5A and FIG. 5B are diagrams showing a method comparing two distance value sequences by applying an actual value to the distance value sequence arrangement of FIG. 4, respectively.

FIG. 6 is a flowchart showing a method of matching a fingerprint based on a comparison method of distance value sequences through a controller 120 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements, but not the exclusion of any other elements.

The fingerprint recognition apparatus and method according to an exemplary embodiment of the present invention performs fingerprint recognition by calculating distance values between one fingerprint feature point and another fingerprint feature point selected in a predetermined direction, and using a sequence in which the distance values are arranged. The fingerprint recognition apparatus and method according to an exemplary embodiment of the present invention will be described in detail below.

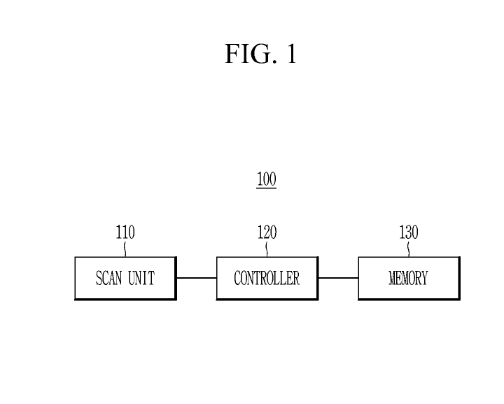

FIG. 1 shows a block diagram showing a fingerprint recognition apparatus 100 according to an exemplary embodiment of the present invention.

As shown in FIG. 1, a fingerprint recognition apparatus 100 according to an exemplary embodiment of the present invention includes a scan unit 110, a controller 120, and a memory 130.

The scan unit 110 scans a fingerprint of a target to be recognized to generate a fingerprint image. That is, the scan unit 110 scans the fingerprint of the target to be recognized through a fingerprint recognition sensor to generate the fingerprint image. The method of scanning the fingerprint image through the scan unit 110 may be known to a person having usual knowledge of the technical field to which the present invention belongs, so a concrete explanation of the art is omitted. The scan unit 110 provides the scanned fingerprint image to the controller 120. The fingerprint image generation of the scan unit 110 is performed in a process of registering the fingerprint and a process of authenticating the fingerprint.

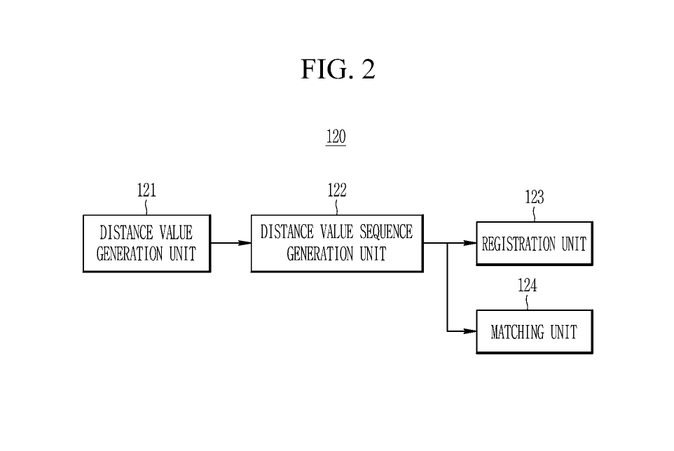

The controller 120 performs the registration process and the authentication process by using the fingerprint image generated from the scan unit 110. FIG. 2 is a block diagram showing a configuration of a controller 120 according to an exemplary embodiment of the present invention. As shown in FIG. 2, the controller 120 according to an exemplary embodiment of the present invention includes a distance value generation unit 121, a distance value sequence generation unit 122, a registration unit 123, and a matching unit 124. The process in which the controller 120 registers the fingerprint image will be described as follows. The controller 120 receives the fingerprint image (hereinafter referred to as ‘a registration fingerprint image’) to be registered through the scan unit 110, and performs distance value extraction, distance value sequence generation, and a registration process by using the registration fingerprint image. The distance value generation unit 121 of the controller 120 calculates the distance value by applying an algorithm for extracting a distance value between the fingerprint feature (minutiae) points in the registration fingerprint image. The distance value sequence generation unit 122 of the controller 120 generates a distance value sequence (DS) according to a predetermined rule using the distance value. The registration unit 123 of the controller 120 registers information on the distance value sequence DS in the memory 130 for later authentication of a user. Here, the distance value sequence DS may be stored and managed based on a security policy after being encrypted.

The process in which the controller 120 authenticates the fingerprint image will be described as follows. The controller 120 receives the fingerprint image (hereinafter referred to as ‘an authentication fingerprint image’) to be authenticated through the scan unit 110, and performs distance value extraction, distance value sequence generation, similarity matching to the registered information, and produces a matching result report by using the authentication fingerprint image. In more detail, the distance value generation unit 121 of the controller 120 calculates a distance value by applying an algorithm for extracting a distance value between fingerprint feature points in an authentication fingerprint image. The distance value sequence generation unit 122 of the control unit 120 generates a distance value sequence DS according to a predetermined rule using the distance value. The matching unit 124 of the controller 120 compares the distance value sequence stored in the memory 124 in the registration process and the distance value sequence generated in the authentication process. The matching unit 124 may report the comparison result to the outside. Meanwhile, the distance value sequence that is encrypted depending on the security policy is decoded to be used in the comparison and matching processes. Also, the distance value sequences in the encryption state may be used in the comparison and matching processes.

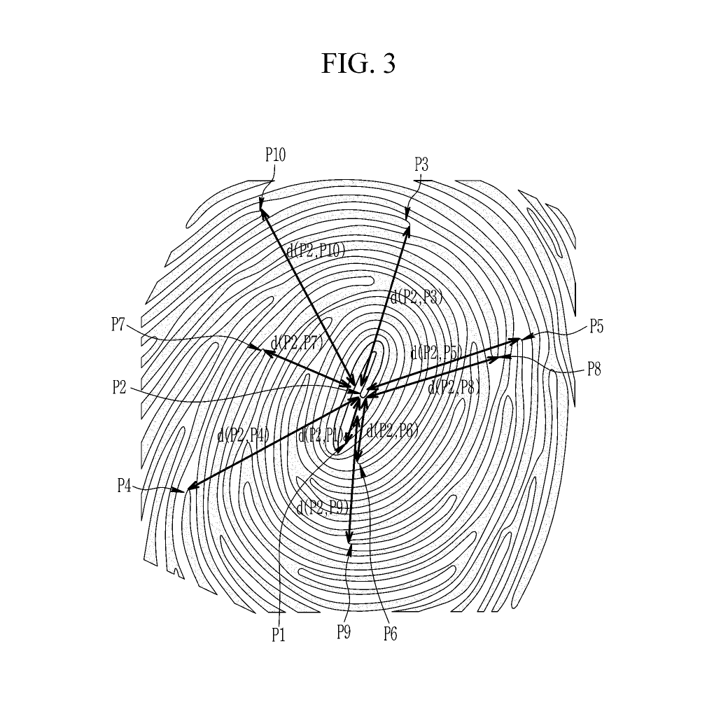

FIG. 3 is a diagram showing a method in which a controller 120 generates a distance value sequence according to an exemplary embodiment of the present invention.

In the following description, a function for calculating the distance value is represented by d (distance). The distance value between the fingerprint feature points may be expressed as an integer or a real number value. In FIG. 3, when the function value for calculating the distance between two fingerprint feature points P1 and P2 is 3, it may be expressed as d(P1, P2)=3.

Meanwhile, to configure (generate) the distance value sequence, it is necessary to define a group for the fingerprint feature points for a predetermined fingerprint feature point (i.e., the ending point or the bifurcation point). Also, to configure the distance value sequence, it is necessary to define a fingerprint feature point to be a reference (hereinafter ‘a reference fingerprint feature point’) in the group of the fingerprint feature points. The controller 120 calculates the distance value between the reference fingerprint feature point and the fingerprint feature points included in the group of the fingerprint feature points. The group of fingerprint feature points may be variously configured by considering several conditions such as characteristics (for example, the shape of the ending point or the bifurcation point) and a magnitude of the distance value. The distance value between the same points when configuring the sequence may be excluded, however the distance value between the same points may be selectively included in the sequence if necessary.

Firstly, to define the distance value sequence, a case considering the characteristic information (the shape of the ending point or the bifurcation point) of the fingerprint feature points will be described. As explained in the background art, the fingerprint feature points may be divided into the ending point and the bifurcation point. To configure the distance value sequence, the group of the fingerprint feature points may only be configured of the ending points (or the bifurcation points), or may be configured by appropriately mixing the ending points and the bifurcation points.

When a group {Q1, Q2, Q3, Q4} configured of the ending points on the fingerprint image is represented as the group of the fingerprint feature points, and a distance value sequence for a fingerprint feature point P1 may be defined by B1′=d(P1,Q1), B2′=d(P1,Q2), B3′=d(P1,Q3), B4′=d(P1,Q4). Similarly, the configuration of the distance value sequence is possible for the group configured of the bifurcation point of the fingerprint image. Also, for n fingerprint feature points including both of the bifurcation point and the ending point, the distance value sequence may be defined between the fingerprint feature point P1 and other fingerprint feature points. If the group of the n fingerprint feature points is expressed by {P1, P2, . . . , Pn}, the distance value sequence for the fingerprint feature point P1 may be represented by B1=d(P1,P2), B2=d(P1,P3), B3=d(P1,P4), . . . , Bn−1=d(P1,Pn). In these examples, P1 becomes a reference fingerprint feature point.

As another example to define the group of the fingerprint feature points, a magnitude of the distance value may be considered. As one example, it may be assumed that it is effective only when the magnitude of the distance value is in a predetermined range. For example, it is assumed that the distance value between the fingerprint feature point P1 and the fingerprint feature points P2, P3, P4, P5, and P6 is calculated like 3=d(P1,P2), 8=d(P1,P3), 4=d(P1,P4), 7=d(P1,P5), 2=d(P1,P6). In this case, if it is assumed that only the distance value is effective as the value of 3 to 7 to configure the distance value sequence, the distance value sequence is configured of 3=d(P1,P2), 4=d(P1,P4), 7=d(P1,P5).

In the configuration (generation) of this distance value sequence, the starting fingerprint feature point (in the above or below example, Q1 or P2) of the sequence may be determined according to a predetermined rule. As one example, any position may be the starting fingerprint feature point. As another example, the fingerprint feature point positioned most north on the fingerprint image may be a starting fingerprint feature point.

In the configuration (generation) of the distance value sequence, the fingerprint feature point to calculate the sequence value of the following order of the starting fingerprint feature point may also be determined according to a predetermined rule. As one example, the sequence value of the following order may be the value of the distance value between the fingerprint feature point positioned in a clockwise direction or a counterclockwise direction from the starting fingerprint feature point on the fingerprint image and the reference fingerprint feature point.

If the method of generating the distance value sequence explained above is applied to FIG. 3, it is as follows. In FIG. 3, the ending point among the fingerprint feature points is assumed to be the group of the fingerprint feature points. Accordingly, the group of the fingerprint feature points is Z={P1, P2, P3, P4, P5, P6, P7, P8, P9, P10}. Also, it is assumed that P2 is the reference fingerprint feature point, and it is assumed that the fingerprint feature point positioned most north in the fingerprint image is the starting fingerprint feature point. In addition, it is assumed that the following fingerprint feature point is in the clockwise direction.

In FIG. 3, the fingerprint feature point (which is the ending point) disposed most north from the reference fingerprint feature point P2 is P3. The distance value between P2 and P3 is 9=d(P2, P3) such that the first value of the distance value sequence becomes 9. The following fingerprint feature point (which is an ending point) in the clockwise direction with respect to P2 based on P3 is P5. The distance between P2 and P5 is 10=d(P2, P5) such that the second value of the distance value sequence becomes 10. The following fingerprint feature point in the clockwise direction with respect to P2 based on P5 is P8. The distance value between P2 and P8 is 8=d(P2, P8) such that the third value of the distance value sequence becomes 8. The following fingerprint feature point in the clockwise direction with respect to P2 based on P8 is P6. The distance value between P2 and P6 is 3=d(P2, P6) such that the fourth value of the distance value sequence becomes 3. The following fingerprint feature point in the clockwise direction with respect to P2 based on P6 is P9. The distance between P2 and P9 is 8=d(P2, P9) such that the fifth value of the distance value sequence becomes 8. The following fingerprint feature point in the clockwise direction with respect to P2 based on P9 is P1. The distance value between P2 and P1 is 1=RC(P2, P1) such that the sixth value of the distance value sequence becomes 1. The following fingerprint feature point in the clockwise direction with respect to P2 based on P1 is P4. The distance value between P2 and P4 is 11=d(P2, P4) such that the seventh value of the distance value sequence becomes 11. The following fingerprint feature point in the clockwise direction with respect to P2 based on P4 is P7. The distance value between P2 and P7 is 8=d(P2, P7) such that the eighth value of the distance value sequence becomes 8. Finally, the following fingerprint feature point in the clockwise direction with respect to P2 based on P7 is P10. The distance value between P2 and P10 is 13=d(P2, P10) such that the ninth value of the distance value sequence becomes 13. Accordingly, the distance value sequence between the groups Z of the ending points for the reference fingerprint feature point P2 is d(P2, P3), d(P2, P5), d(P2, P8), d(P2, P6), d(P2, P9), d(P2, P1), d(P2, P4), d(P2, P7), and d(P2, P10), and the detailed value is the sequence such as 9, 10, 8, 3, 8, 1, 11, 8, and 13.

The controller 120 according to an exemplary embodiment of the present invention is used for fingerprint authentication by using the distance value sequence generated by the above method. That is, the controller 120 generates the distance value sequence from the registration fingerprint image to be previously registered, generates the distance value sequence from the authentication fingerprint image, and compares two distance value sequences with each other to perform the authentication. Hereinafter, the distance value sequence generated from the registration fingerprint image is referred to as ‘a registration distance value sequence’, and the distance value sequence generated from the authentication fingerprint image is referred to as ‘an authentication distance value sequence’.

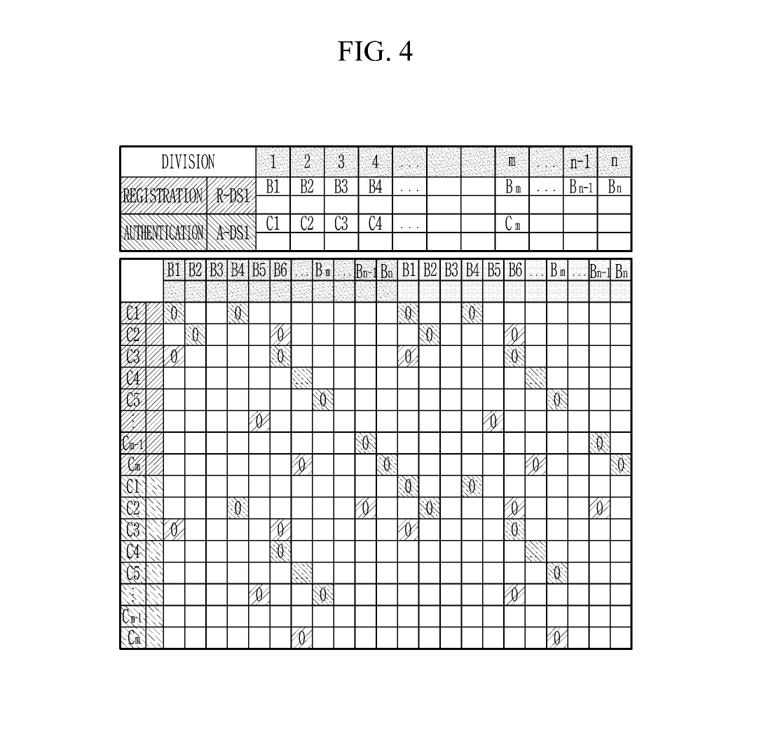

FIG. 4 is a diagram showing an authentication method of a controller 120 according to an exemplary embodiment of the present invention. The below-described authentication method may be performed in the matching unit 124 of the controller 120. In FIG. 4, the registration distance value sequence is represented by ‘R-DS1’, and the authentication distance value sequence is represented by ‘A-DS1’.

The controller 120 compares the registration distance value sequence R-DS1 and the authentication distance value sequence A-DS1 with each other to perform the fingerprint authentication. When the registration fingerprint image and the authentication fingerprint image are obtained from the same user, partial sequences of the distance value sequence are similar to each other. The controller 120 according to an exemplary embodiment of the present invention performs the fingerprint authentication by using the similarity of the partial sequences. In FIG. 4, the registration distance value sequence R-DS1 is represented by B1, B2, B3, B4, . . . , Bn−1, Bn, and the authentication distance value sequence A-DS1 is represented by C1, C2, C3, C4, . . . , Cm−1, Cm. Meanwhile, the registration distance value sequence R-DS1 and the authentication distance value sequence A-DS1 may have different lengths from each other. In FIG. 4, n≥m is assumed, however m≥n may be applied.

As shown in FIG. 4, the controller 120 duplicates the registration distance value sequence twice in the row, and duplicates the authentication distance value sequence twice in the column. The controller 120 calculates and allocates a deviation of two distance values in an entry where each row and each column cross each other. FIG. 4 only shows a case that the entry is ‘0’ for convenience. The controller 120 performs the fingerprint authentication by considering a type of the entry in which the deviation shown on a matrix is zero. The controller 120 calculates a length and a frequency for a string of zeros continuously connected on the matrix with a diagonal direction, and uses the calculated values to the fingerprint authentication.

Meanwhile, the controller 120 may reflect whether there are several entry values other than zero to the fingerprint authentication among the strings of zeros continuously connected in the diagonal direction on the matrix. The distance value may not be accurate when noise occurs in the fingerprint scan, so that the registration distance value sequence and the authentication distance value sequence may not coincide with each other. Accordingly, the entry value of the matrix representing the deviation between two sequences (i.e., the registration distance value sequence and the authentication distance value sequence) may be a value that is not zero. By reflecting this condition, the controller 120 according to an exemplary embodiment of the present invention may additionally specify a weight value.

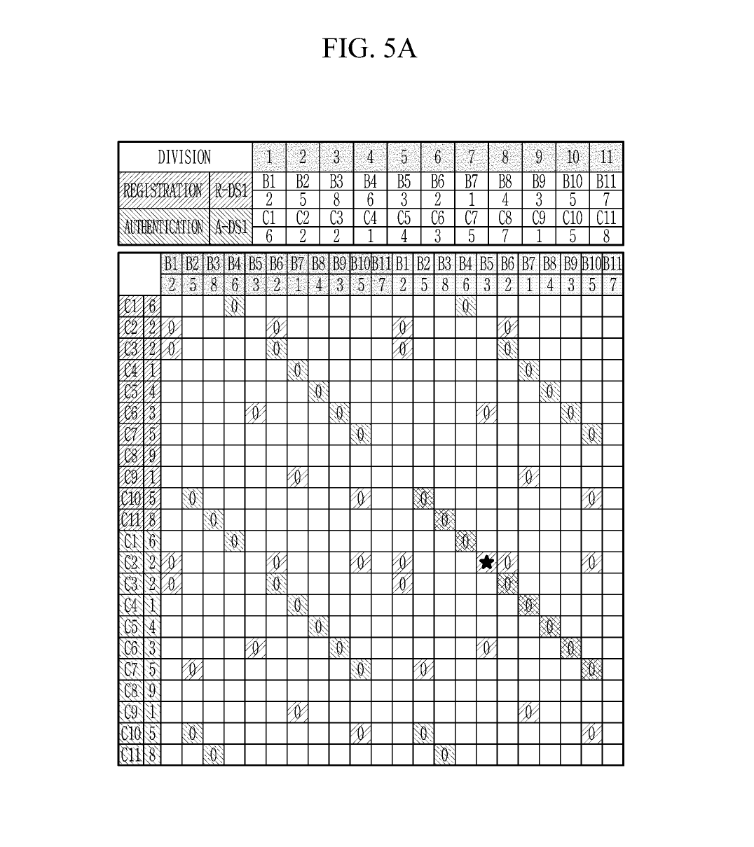

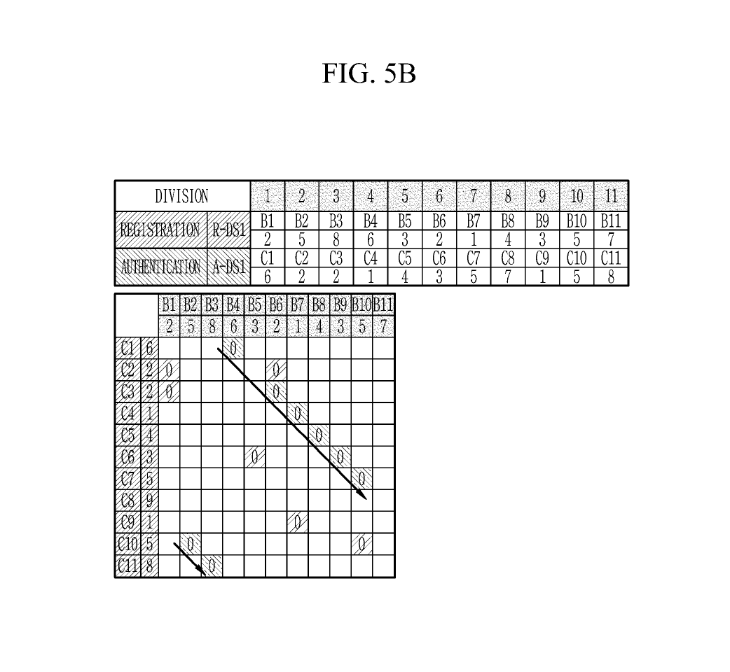

FIG. 5A and FIG. 5B are diagrams showing a method of comparing two distance value sequences by applying an actual value to the distance value sequence arrangement of FIG. 4, respectively.

In FIG. 5A and FIG. 5B, it is assumed that the registration distance value sequence is B1=2, B2=5, B3=8, B4=6, B5=3, B6=2, B7=1, B8=4, B9=3, B10=5, and B11=7, and that the authentication distance value sequence is C1=6, C2=2, C3=2, C4=1, C5=4, C6=3, C7=5, C8=9, C9=1, C10=5, and C11=8. Also, it is assumed that the distance value sequence is generated in the clockwise direction with the start of an arbitrary fingerprint feature point.

As shown in FIG. 5A, the controller 120 duplicates two distance value sequences (i.e., the registration distance value sequence and the authentication distance value sequence) twice in the row and the column. Meanwhile, as shown in FIG. 5B, the controller 120 may display two distance value sequences (i.e., the registration distance value sequence and the authentication distance value sequence) one by one in the row and the column. FIG. 5A is the same FIG. 5B except for displaying two distance value sequences one by one such that it is described below based on FIG. 5A. In FIG. 5A, an entry in which each row and column intersect indicates a value of 0 in a deviation of two distance values. Referring to the matrix of FIG. 5A, the diagonal direction sequential 0 column of the length 3 is displayed in one place, and this may be represented by {(B2,C10), (B3,C11), (B4,C1)} as an index of the row and the column. Also, the diagonal direction sequential 0 column of the length 5 is displayed in one place, and this may be represented by {(B6,C3), (B7,C4), (B8,C5), (B9,C6), (B10,C7)} as an index of the row and the column.

Meanwhile, the controller 120 may apply a predetermined weight value for each length of the diagonal direction sequential 0 column represented on the matrix to calculate a score for similarity. For example, the controller 120 may multiply the diagonal direction sequential 0 column of the length 3 by three (3) and the diagonal direction sequential 9 of the length 5 by five (5). Here, the weight value may be determined by a statistical distribution depending on the length of the diagonal direction sequential 0 column. The controller 120 determines the similarity of two distance value sequences based on the calculated score value. Meanwhile, in FIG. 5A, since one entry value that is not zero exists between the diagonal direction sequential 0 column of the length 3 and the diagonal direction sequential 0 column of the length 5, the controller 120 may take an additional weight value (indicated by an asterisk) for this case. Also, the controller 120 may take an additional weight in consideration of the size of the non-zero entry value.

In the above description, a description has been made on the basis of a value of 0 being a deviation of two distance values, but it is also applicable to a continuous column composed of a certain range of values. For example, it can reflect the appearance of continuous columns composed of values of less than or equal to ε in the diagonal direction.

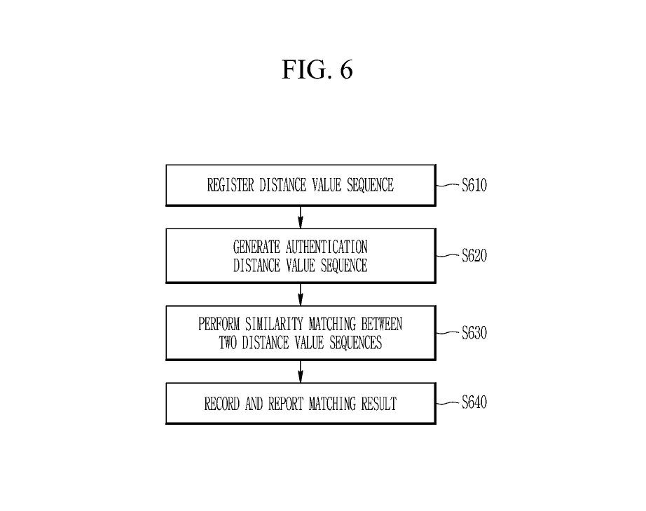

FIG. 6 is a flowchart showing a method of matching a fingerprint based on a comparison method of distance value sequences through a controller 120 according to an exemplary embodiment of the present invention.

As described above, since the distance value sequence is defined by the group of the one fingerprint feature point and other fingerprint feature points, multiple different distance value sequences may be generated on one fingerprint image. These multiple different distance value sequences are generated in the registration process and the authentication process.

The controller 120 registers at least one distance value count sequence according to the predetermined policy in the registration process (S610). For example, the controller 120 may generate and register a distance value sequence for each of all the fingerprint feature points using the scanned registration fingerprint image. As another example, the controller 120 may generate a distance value sequence for arbitrarily selected fingerprint feature points.

The controller 120 generates at least one authentication distance value sequence according to the predetermined policy in the authentication process (S620). For example, the controller 120 may generate and register a distance value sequence for each of all the fingerprint feature points using the scanned authentication fingerprint image.

The controller 120 performs similarity matching by comparing the registration distance value sequence registered in the step S610 and the authentication distance value sequence generated in the steps S620 (S630).

That is, the controller 120 calculates the similarity between the two distance value sequences by using the comparison method described in FIG. 4, FIG. 5A, and FIG. 5B. For example, when comparing the two distance value sequences in which there is no similarity at all, the frequency of displaying the diagonal direction sequential 0 column of the specific length will be very low. Also, the score (the calculation value) of the similarity will be low. If two distance value sequences generated in the same fingerprint image are compared, the frequency of displaying the diagonal direction sequential 0 column of the specific length will appear high and the similarity scores will also appear high. Meanwhile, a certain criterion and policy can be predetermined for the similarity score or the number of consecutive zeros in the diagonal direction of a specific length.

The controller 120 may record the result for the similarity matching performed in the step S630 to the memory and may report the matching result to the user (S640).

As above-described, according to an exemplary embodiment of the present invention, since the distance value sequence is used, the information that is not changed in phase on the fingerprint image may be extracted even for changes such as a rotation and a transition of the fingerprint image. Accordingly, an alignment function can be improved and a fingerprint recognition rate can be improved even when the fingerprint image is changed.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. A method for performing fingerprint recognition by using a fingerprint image scanned by a fingerprint recognition apparatus, comprising:
extracting a plurality of fingerprint feature points in the fingerprint image;
configuring a predetermined group among the plurality of fingerprint feature points;
calculating a distance value between first fingerprint feature points included in the group; and
generating a distance value sequence by using the distance value.

2. The method of claim 1, wherein
the calculating comprises:
configuring a reference fingerprint feature point as a reference among the first fingerprint feature points; and
calculating a distance value between the reference fingerprint feature point and the first fingerprint feature points.

3. The method of claim 2, wherein
the generating comprises
generating the distance value sequence between the reference fingerprint feature point and the first fingerprint feature points, by arranging the distance value calculated in a predetermined direction.

4. The method of claim 1, further comprising
performing authentication by using the distance value sequence.

5. The method of claim 4, wherein
the performing authentication comprises
performing authentication by comparing a registration distance value sequence as the distance value sequence generated in a registration process and an authentication distance value sequence as the distance value sequence generated in an authentication process.

6. The method of claim 5, wherein
the performing authentication comprises:
disposing the registration distance value sequence in a first direction on a matrix;
disposing the authentication distance value sequence in a second direction on the matrix;
calculating a value difference of the registration distance value sequence and the authentication distance value sequence; and
calculating a score of a similarity by using a feature on which the value difference is disposed on the matrix.

7. The method of claim 6, wherein
the calculating of the score of the similarity comprises calculating the score of the similarity by using a feature in which the value difference is 0 or a certain range of the value differences is continuously disposed on a diagonal on the matrix.

8. The method of claim 1, wherein
the plurality of fingerprint feature points comprise an ending point of a ridge and a bifurcation point of the ridge.

9. The method of claim 3, wherein
the predetermined direction is a clockwise direction or a counterclockwise direction.

10. A method for performing fingerprint recognition by a fingerprint recognition apparatus, comprising:
extracting a plurality of first fingerprint feature points on a fingerprint image to be registered;
generating a registration distance value sequence by calculating a distance value between the plurality of first fingerprint feature points;
extracting a plurality of second fingerprint feature points on a fingerprint image to be authenticated;
generating an authentication distance value sequence by calculating a distance value between the plurality of second fingerprint feature points; and
performing authentication by comparing the registration distance value sequence and the authentication distance value with each other.

11. The method of claim 10, wherein
the generating of the registration distance value sequence comprises:
configuring a first fingerprint feature point from the plurality of first fingerprint feature points;
calculating a distance value in a predetermined direction between at least one fingerprint feature point among the plurality of first fingerprint feature points and the first fingerprint feature point; and
generating the registration distance value sequence by arranging the distance value calculated in the predetermined direction.

12. The method of claim 10, wherein
the generating of the authentication distance value sequence comprises:
configuring a first fingerprint feature point from the plurality of second fingerprint feature points;
calculating a distance value in a predetermined direction between at least one fingerprint feature point among the plurality of second fingerprint feature points and the first fingerprint feature point; and
generating the authentication distance value sequence by arranging the distance value calculated in the predetermined direction.

13. The method of claim 10, wherein
the performing of authentication comprises:
disposing the registration distance value sequence in a first direction on a matrix;
disposing the authentication distance value sequence in a second direction on the matrix;
calculating a value difference of the registration distance value sequence and the authentication distance value sequence; and
performing authentication by using a feature on which the value difference is disposed on the matrix.

14. The method of claim 13, wherein
the disposing in the first direction comprises consecutively disposing the registration distance value sequence in the first direction twice, and
the disposing in the second direction comprises consecutively disposing the authentication distance value sequence in the second direction twice.

15. An apparatus for fingerprint recognition, comprising: a scan unit scanning a fingerprint of a target to be recognized to generate a fingerprint image; and
a controller extracting a plurality of fingerprint feature points from the fingerprint image, calculating a distance value between the plurality of fingerprint feature points, and generating a distance value sequence by using the distance value.

16. The apparatus for the fingerprint recognition of claim 15, wherein
the controller configures a reference fingerprint feature point as a reference among the plurality of fingerprint feature points, and calculates a distance value between the reference fingerprint feature point and the plurality of fingerprint feature points.

17. The apparatus for the fingerprint recognition of claim 16, wherein
the controller arranges the distance value calculated in a predetermined direction between the reference fingerprint feature point and the plurality of fingerprint feature points to generate the distance value sequence.

18. The apparatus for the fingerprint recognition of claim 15, wherein
the fingerprint image comprises a registration fingerprint image scanned in a registration process and an authentication fingerprint image scanned in an authentication process, and
the controller compares a registration distance sequence as the distance value sequence corresponding to the registration fingerprint image and an authentication distance value sequence as the distance value sequence corresponding to the authentication fingerprint image with each other to perform authentication.

19. The apparatus for the fingerprint recognition of claim 18, wherein
the controller disposes the registration distance value sequence and the authentication distance value sequence in different directions on a matrix, calculates a value difference of the registration distance value sequence and the authentication distance value sequence, and performs authentication by using a feature on which the value difference is disposed on the matrix.

20. The apparatus for the fingerprint recognition of claim 17, wherein
the plurality of fingerprint feature points are an ending point of a ridge or a bifurcation point of the ridge, and the predetermined direction is a clockwise direction or a counterclockwise direction.
